(19) United States
(12) Patent Application Publication
(10) Pub. No.: US 2015/0054915 A1
(43) Pub. Date: Feb. 26, 2015

(54) MULTIPLE-VIEW IMAGE DISPLAYING APPARATUS FOR IMPROVING PICTURE QUALITY AND A METHOD THEREOF

(71) Applicant: SAMSUNG ELECTRONICS CO., LTD., Suwon-si (KR)

(72) Inventors: Seok-Man Jeong, Hwaseong-si (KR); Shin-Haeng Kim, Yongin-si (KR); Tae-Gyoung Ahn, Yongin-si (KR)

(73) Assignee: SAMSUNG ELECTRONICS CO., LTD., Suwon-si (KR)

(21) Appl. No.: 14/390,267

(22) PCT Filed: Apr. 1, 2013
(86) PCT No.: PCT/KR2013/002694

§ 371 Date: Oct. 2, 2014

Related U.S. Application Data
(60) Provisional application No. 61/618,909, filed on Apr. 2, 2012.

(30) Foreign Application Priority Data
Mar. 29, 2013 (KR) 10-2013-0034011

(51) Int. Cl. H04N 13/00; H04N 13/04

(52) U.S. Cl. CPC H04N 13/0018; H04N 13/0029; H04N 13/0033; H04N 13/0409; H04N 13/0404
USPC 348/43

(57) ABSTRACT

The present invention discloses a method for improving picture quality by an image displaying apparatus, which includes the steps of eliminating motion judder from an input image by a motion judder elimination part, changing the frame rate of the image rid of the motion judder by a frame rate change part, converting the image of the changed frame rate into a multi-view image involving the images determined in proportion to the number of angles by an image converter, an displaying the multi-view image by a displaying part.

### TECHNICAL FIELD

The present invention relates to an image displaying, and more particularly to a multi-view image displaying apparatus for improving picture quality of a multi-view image and a method thereof.

### BACKGROUND ART

On the strength of the development of an electronic technology, a field of home appliances such as a television (TV) is quickly developing. Especially, in a television apparatus field, a new concept of a three-dimensional (3D: 3-dimension) image technique, which provides liveliness and reality by enabling a viewer to experience a visible a three-dimensional effect by adding depth information in a prior two-dimensional (2D: 2-dimension) image, is commercialized. The 3D image technique uses a stereoscopy scheme utilizing a parallax of both eyes, and is a technique that provides the 3D image capable of providing liveliness and reality to a viewer, by generating a perspective of the 3D image when two different 2D images viewed by a left eye and a right eye, respectively, are transferred to a brain through a retina, and the brain combines the two images.

However, in such a 3D image technique, a filter device which simultaneously displays an image viewed by a left eye and an image viewed by a right eye and enables both eyes to separately view the images, is absolutely necessary. Currently, in a commercialized 3D image displaying apparatus, in order to enjoy a 3D image provided from the 3D image displaying apparatus, a viewer should wear special glasses as the filter device. In addition, problems arise wherein a multi-tasking during the viewing of the 3D image is impossible due to the wearing of the special glasses.

Therefore, recently, research and development for a glasses-less 3D image technique as an alternative for the 3D image technique are being actively progressed. The glasses-less 3D image technique is a technique which enables a viewer to enjoy the 3D image without wearing the special glasses, and is largely classified as a parallax barrier scheme or a lenticular lens scheme according to an image division scheme.

FIG. 1A is a view illustrating an example of a glasses-less 3D image technique implemented in a parallax barrier scheme.

Referring to FIG. 1A, the parallax barrier scheme means a scheme which enables a left eye and a right eye to view different images by installing a display adjustment device having a space at predetermined intervals, that is a parallax barrier, in front of a screen in a liquid crystal shape. That is, a visible area of the left eye is an area marked as L on the screen, and a visible area of the right eye is an area marked as R on the screen.

FIG. 1B is a view illustrating an example of a glasses-less 3D image technique implemented in a lenticular lens scheme.

Referring to FIG. 1B, the lenticular lens scheme means a scheme which enables a left eye and a right eye to view different images through a refraction of light by installing a cylindrical lens, that is a lenticular lens, in front of a screen. That is, a visible area of the left eye is an area marked as L on the screen, and a visible area of the right eye is an area marked as R on the screen.

In addition, these days, research and development for a multi-view image technique which is more advanced than the glasses-less 3D image technique are actively being progressed. The multi-view image technique enables a viewer to experience more liveliness by additionally applying a multi-view technique, which divides a user-visible-screen-area into several windows and enables a viewer to view a screen corresponding to the divided window according to a movement of a viewpoint of the viewer, to the above-mentioned glasses-less 3D image technique.

However, even in the multi-view image provided from such a multi-view image technique, a screen vibration phenomenon, that is motion judder, which is the same as the that occurring in the conventional High Definition (HD) TV, occurs, and this causes a critical problem in picture quality of an image provided to a user. Especially, in currently commercialized 3D images, a minutely recognized change of an image may have a large effect on picture quality in the multi-view image.

In addition, the picture quality problem in the multi-view image is related with a vision health problem, and thus a method capable of improving a picture quality of an image provided to a viewer by eliminating the motion judder in the multi-view image is requested.

### DETAILED DESCRIPTION OF THE INVENTION

### Technical Problem

The present invention provides a multi-view image displaying apparatus for improving a picture quality by eliminating motion judder of a multi-view image, and a method thereof.

In addition, the present invention provides a multi-view image displaying apparatus for improving picture quality by changing the frame rate of a multi-view image, and a method thereof.

In addition, the present invention provides a multi-view image displaying apparatus for improving a picture quality by eliminating motion judder and changing the frame rate before converting an image into a multi-view image, and a method thereof.

### Technical Solution

An apparatus according to an embodiment, which is an image displaying apparatus for improving picture quality according to an embodiment of the present invention, comprises a motion judder elimination unit that eliminates motion judder from an input image, a frame rate change unit that changes the frame rate of the image in which the motion judder is eliminated, an image converter that converts the image of which the frame rate is changed into a multi-view image including screens determined in proportion to the number of angles, and a displaying unit that displays the multi-view image.

A method according to an embodiment of the present invention, which is a method of improving picture quality by an image displaying apparatus, comprises a step of eliminating motion judder from an input image by a motion judder unit, a step of changing the frame rate of the image in which the motion judder is eliminated, by a frame rate change unit, a step of converting the image of which the frame rate is changed into a multi-view image including screens determined in proportion to the number of angles, by an image converter, and a step of displaying the multi-view image by the display unit.

### Advantageous Effects

The present invention can more excellently improve picture quality by eliminating motion judder of a multi-view image.

### BRIEF DESCRIPTION OF THE DRAWINGS

FIG. 1A is a view illustrating an example of a glasses-less 3D image technique implemented in a parallax barrier scheme;

FIG. 1B is a view illustrating an example of a glasses-less 3D image technique implemented in a lenticular lens scheme;

FIG. 2 is a view illustrating a structure of a multi-view image displaying apparatus according to a first embodiment of the present invention;

FIG. 3 is a view illustrating an example of a pull-down process in the multi-view image displaying apparatus according to the first embodiment of the present invention;

FIG. 4 is a view illustrating a structure of a multi-view image displaying apparatus according to a second embodiment of the present invention;

FIG. 5 is a view illustrating an example of an operation of a frame rate change in the multi-view image displaying apparatus according to the second embodiment;

FIG. 6 is a flowchart illustrating a method of improving picture quality of a multi-view image in the multi-view image displaying apparatus according to the first embodiment of the present invention; and

FIG. 7 is a flowchart illustrating a method of improving picture quality of a multi-view image in the multi-view image displaying apparatus according to the second embodiment of the present invention.

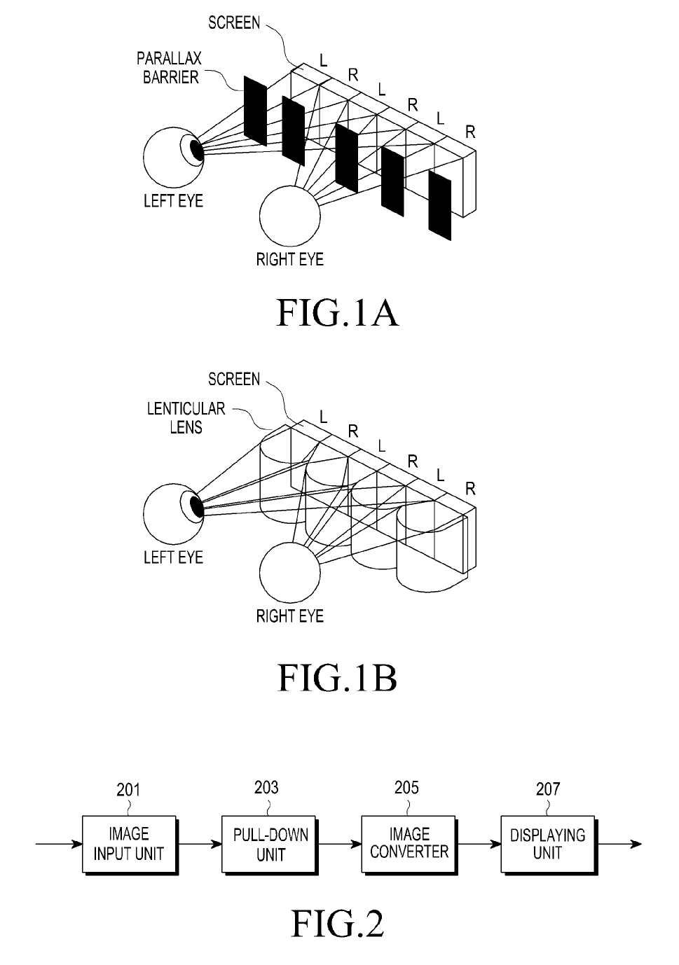

### MODE FOR CARRYING OUT THE INVENTION

Hereinafter, exemplary embodiments of the present invention will be described in detail with reference to the accompanying drawings. Further, in the following description of the present invention, a detailed description of known functions and configurations incorporated herein will be omitted when it may make the subject matter of the present invention rather unclear. Terms described later are defined in consideration of functions of the present disclosure, but may vary according to the intention or convention of a user or operator. Therefore, the definitions of the terms should e determined based on the contents throughout the specification.

FIG. 2 is a view illustrating a structure of a multi-view image displaying apparatus according to a first embodiment of the present invention.

Referring to FIG. 2, the multi-view image displaying apparatus includes an image input unit 201, a pull-down unit 203, a multi-view image change unit 205 and a multi-view image displaying unit 207. Here, the multi-view image displaying apparatus means an apparatus displaying an image to which a glasses-less 3D image technique is applied, and for example, the multi-view image displaying apparatus may be a TV. When the multi-view image displaying apparatus is the TV, the multi-view image displaying apparatus processes an image input from a DVD player or a Blu-ray player, and outputs the processed image through the multi-view image displaying unit 207.

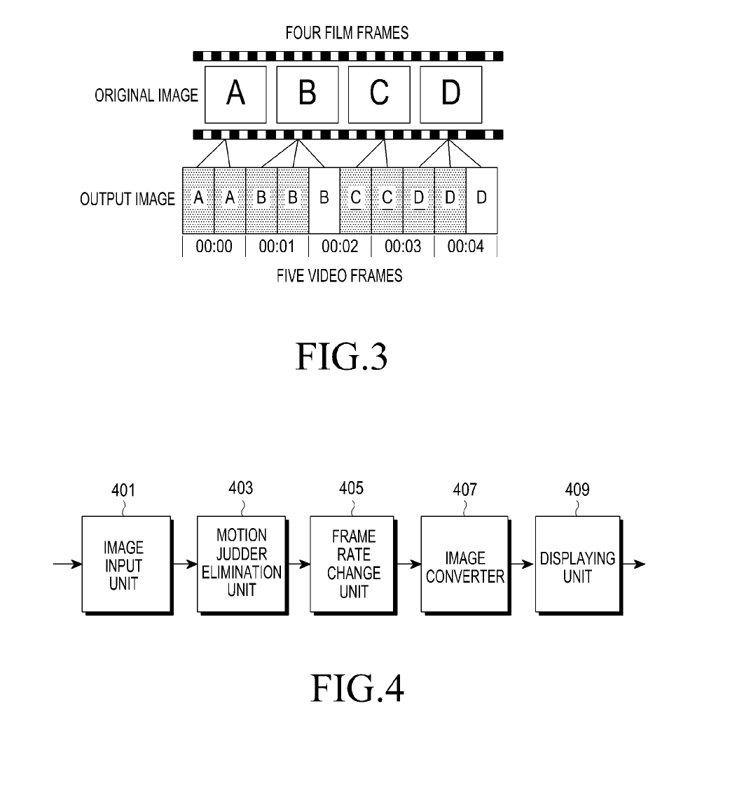

The image input unit 201 outputs the input image to the pull-down unit 203, and the pull-down unit 203 performs a pull-down process on the input image and outputs the input image on which the pull-down process is performed to the multi-view image converter 205. The pull-down process means generating an input image frame corresponding to an output image frame size, and the pull-down process will be described in more detail through FIG. 3 described later.

The multi-view image converter 205 receives the image on which the pull-down process is performed, converts the image into a multi-view image, and displays the multi-view image to a user through the multi-view image displaying unit 207. The image conversion means converting one screen into screens having different angles, and in a case of a currently commercialized 3D TV, converting one screen into a screen for each eye, that is a left eye screen and a right eye screen, corresponds to the image conversion.

In a case of the multi-view TV to which the glasses-less 3D technique is applied, since one screen is converted into screens having different angles, the multi-view TV to which the glasses-less 3D technique is applied is similar to the image conversion technique of the 3D TV described above, and since the number of screens to be generated is N and not two, the multi-view TV, to which the glasses-less 3D technique is applied, is different from the above-mentioned image conversion technique of the 3D TV. The number (N) of screens to be generated is determined in proportion to the number of angles, and for example, may be calculated as ‘N=the number of angles+2’.

In addition, in the case of the multi-view TV, in order to convert input image data into multi-view image data which may be output, a complex conversion technique is necessary. The conversion technique includes a depth-based scheme and a multi-layer scheme, and generally the conversion technique of the depth-based scheme is more commonly used. Simply describing the conversion technique of the depth-based scheme, the conversion technique of the depth-based scheme is a technique which generates N virtual views from one image through depth values of each pixel constituting the image.

FIG. 3 is a view illustrating an example of the pull-down process in the multi-view image displaying apparatus according to the first embodiment of the present invention.

Referring to FIG. 3, when the multi-view image displaying apparatus receives an image generated at 24 frames per second (24 fps) and generates an image at 30 frames per second (30 fps), the multi-view image displaying apparatus performs the pull-down process on the input image by applying a 2:3 pull-down scheme.

When it is assumed that the input image, that is an original image, is four frames A, B, C and D, the pull-down unit 203 implements A and A which are the shapes of the original image and a copy image, B, B and B which are the shapes of the original image, the copy image and the copy image, C and C which the shapes of the original image and the copy image, and D, D and D which are the shapes of the original image, the copy image and the copy image, for each frame to generate five frames, and outputs the generated frames. However, in this scheme, the number of screens inserted into the middle is not constant like 2+3+2+3, and thus a motion judder occurs.

FIG. 4 is a view illustrating a structure of a multi-view image displaying apparatus according to a second embodiment of the present invention.

Referring to FIG. 4, the multi-view image displaying apparatus includes an image input unit 401, a motion judder elimination unit (motion judder canceller) 403, a frame rate change unit (frame rate converter) 405, a multi-view image converter 407 and a displaying unit 409. Here, the multi-view image displaying apparatus means an apparatus displaying an image to which a glasses-less 3D image technique is applied, and for example, the multi-view image displaying apparatus may be a TV. When the multi-view image displaying apparatus is the TV, the multi-view image displaying apparatus processes an image input from a DVD player or a Blu-ray player, and outputs the processed image through the multi-view image displaying unit 409.

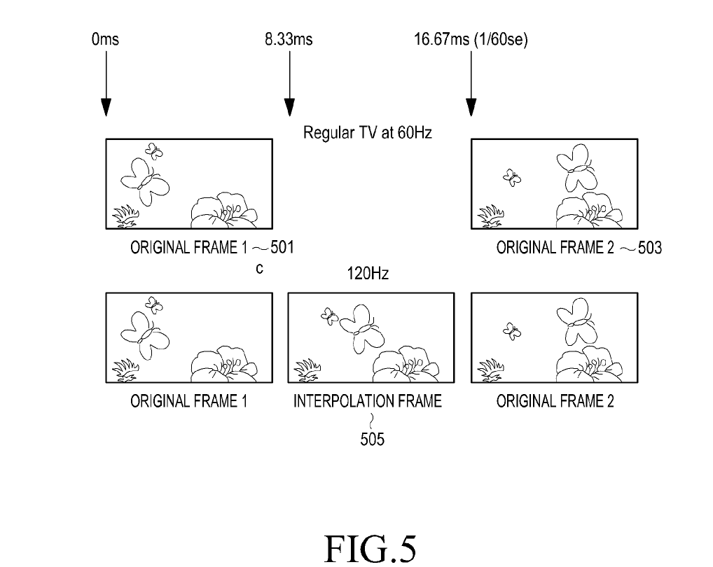

The image input unit 401 outputs the input image to the motion judder elimination unit 403, and the motion elimination unit 402 eliminates motion judder in the input image, and outputs key frame indexes of the image in which the motion judder is eliminated and an original image to the frame rate change unit 405. The frame rate change unit 405 changes the frame rate of the image in which the motion judder is eliminated in consideration of the key frame indexes of the image in which the motion judder is eliminated and the original image, and outputs the image of which the frame rate is changed to the multi-view image converter 407. The operation of the frame rate change unit 405 will be described in more detail in FIG. 5 described later.

The multi-view image converter 407 receives the image of which the frame rate is changed, converts the image into a multi-view image, and displays the multi-view image to a user through the multi-view image displaying unit 409. The image conversion means converting one screen into screens having different angles, and in a case of a currently commercialized 3D TV, converting one screen into a screen for each eye, that is a left eye screen and a right eye screen, corresponds to the image conversion.

In a case of the multi-view TV to which the glasses-less 3D technique is applied, since one screen is converted into screens having different angles, the multi-view TV to which the glasses-less 3D technique is applied is similar to the image conversion technique of the 3D TV described above, and since the number of screens to be generated is N and not two, the multi-view TV, to which the glasses-less 3D technique is applied, is different from the above-mentioned image conversion technique of the 3D TV. The number (N) of screens to be generated is determined in proportion to the number of angles, and for example, may be calculated as ‘N=the number of angles+2’.

In addition, in the case of the multi-view TV, in order to convert input image data into multi-view image data which may be output, a complex conversion technique is necessary. The conversion technique includes a depth-based scheme and a multi-layer scheme, and generally the conversion technique of the depth-based scheme is more commonly used. Simply describing the conversion technique of the depth-based scheme, the conversion technique of the depth-based scheme is a technique which generates N virtual views from one image through depth values of each pixel constituting the image.

FIG. 5 is a view illustrating an example of the operation of the frame rate change in the multi-view image displaying apparatus according to the second embodiment.

Referring to FIG. 5, when the multi-view image displaying apparatus receives an image of which a driving frequency is 60 Hz and outputs an image of which a driving frequency is 120 Hz, the multi-view image displaying apparatus changes the frame rate of the input image and outputs the input image of which the frame rate is changed. A method of changing the frame rate is largely separated into a motion estimation scheme estimating whether it is moved to which position in temporality before and after frames, and a motion compensation scheme compensating for movement by inserting an interpolation frame which is generated according to a result of the estimation between previous and subsequent frames.

When it is assumed that the input image, that is an original frame 1 501 is progressed at 0 ms and an original frame 2 503 is progressed at 16.67 ms, the frame rate change unit 405 estimates a movement between the original frame 1 501 and the original frame 2 503 to generate an interpolation frame 505, and progresses the generated interpolation frame 505 at 8.33 ms which is the middle point between the original frame 1 501 and the original frame 2 503 to compensate for the movement. As described above, since the frame rate change unit 405 uses the interpolation frame 503 generated by estimating the movement based on the previous and subsequent frames, differently from a pull-down scheme, the frame rate change unit 405 can eliminate motion judder occurring in a case of the application of the pull-down scheme and simultaneously improve picture quality by compensating for movement between frames.

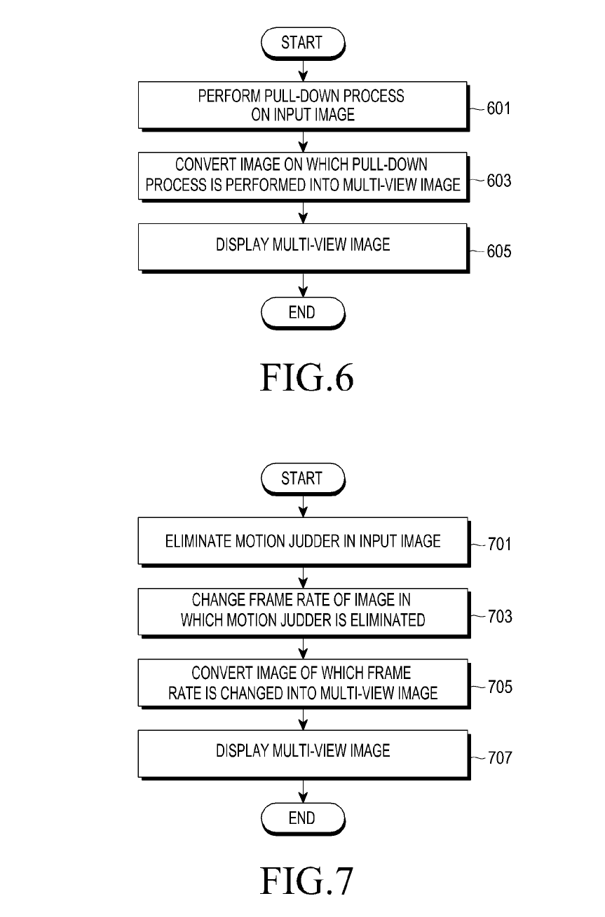

FIG. 6 is a flowchart illustrating a method of improving picture quality of a multi-view image in the multi-view image displaying apparatus according to the first embodiment of the present invention.

Referring to FIG. 6, in step 601, the pull-down part of the multi-view image displaying apparatus performs the pull-down process on the input image, and then step 603 is proceeded to. Here, the pull-down process means constituting output image frames so that an original image and a copy image of the original image are alternately progressed with respect to each of input image frames. Since the pull-down process is described in detail through FIG. 3, the description thereof is omitted here.

In step 603, the multi-view image converter of the multi-view image displaying apparatus converts the image, on which the pull-down process has been performed, into the multi-view image to which the glasses-less 3D technique is applied, and then step 605 is proceeded to. Here, the multi-view image is different from the 3D image in a point wherein the number of screens is determined in proportion to the number of angles, and for example, the number (N) of screens may be calculated by ‘N=the number of angles+two screens’.

In step 605, the multi-view image displaying part of the multi-view image displaying apparatus displays the multi-view image.

FIG. 7 is a flowchart illustrating a method of improving picture quality of a multi-view image in the multi-view image displaying apparatus according to the second embodiment of the present invention.

Referring to FIG. 7, in step 701, an input part of the multi-view image displaying apparatus eliminates motion judder, and then step 703 is proceeded to. Here, motion judder means a screen vibration phenomenon incurred owing to a non-continuous disconnection of each screen, and is mainly incurred when the same frames are copied and progressed like in the pull-down scheme.

In step 703, the frame rate change part of the multi-view image displaying apparatus changes the frame rate of the image in which the motion judder is eliminated, and then step 705 is proceeded to. Here, the operation of the frame rate change part estimates movement based on previous and subsequent frames, generates the interpolation frame to be inserted therebetween, and inserts the generated interpolation frame between the previous and subsequent frames, thereby improving picture quality by compensating for the movement between the frames.

In step 705, the multi-view image converter of the multi-view image displaying apparatus converts the image of which the frame rate is changed into the multi-view image to which the glasses-less 3D technique is applied, and then step 707 is proceeded to. Here, the multi-view image is different from the 3D image in a point wherein the number of screens is determined in proportion to the number of angles, and for example, the number (N) of screens may be calculated by ‘N=the number of angles+two screens’.

In step 707, the multi-view image displaying part of the multi-view image displaying apparatus displays the multi-view image.

Meanwhile, in the detailed description of the present invention, a specific embodiment is described, but it is certain that the embodiment may be variably modified within a limit of the scope of the present invention. Therefore, the scope of the present invention should not be limited to the described embodiments, and should be determined by claims described later and equivalents of the claims.

In addition, the multi-view image displaying apparatus and the method of improving picture quality of the multi-view image displaying apparatus according to the embodiment of the present invention may be implemented as a hardware, a software or a combination thereof. The software may be stored in, for example, a volatile or nonvolatile storage device such as a storage device of a ROM, regardless of a deletion function or rewriting function, for example, a memory such as a RAM, a memory chip, a device or an integrated circuit, or for example, a storage medium optically or magnetically writable and readable by a machine (e.g., a computer) such as a CD, a DVD, a magnetic disk or a magnetic tape. A method of updating a graphic screen of the present invention may be implemented by a computer or a mobile terminal including a control unit and a memory, the memory being an example of a machine-readable storage medium which is proper to store a program or programs implementing and instructing embodiments of the present invention.

Therefore, the present invention includes a program including a code for implementing an apparatus or a method written in any claim of the present specification, and a storage medium which may be readable by a machine (e.g., computer) and stores the program. In addition, the program may be electronically transferred through any medium such as a communication signal which is transferred through a wired or wireless connection, and the present invention properly includes equivalents thereto.

In addition, the multi-view image displaying apparatus according to an embodiment of the present invention may receive the program from a program providing apparatus connected through a wired or wireless connection to store the program. The program providing apparatus may include a program including instructions performing a predetermined contents protection method by the graphic processing apparatus, a memory that stores information required in the contents protection method, a communication unit that performs wired or wireless communication with the graphic processing apparatus, and a control unit that transmits a corresponding program to the transmitting and receiving apparatus automatically or according to a request of the graphic processing apparatus.

1. An image displaying apparatus for improving picture quality comprising:
a motion judder elimination unit that eliminates motion judder from an input image;
a frame rate change unit that changes the frame rate of the image in which the motion judder is eliminated;
an image converter that converts the image of which the frame rate is changed into a multi-view image including screens determined in proportion to the number of angles; and
a displaying unit that displays the multi-view image.

2. The image displaying apparatus as claimed in claim 1, wherein the frame rate change unit estimates a motion in previous and subsequent frames of the image in which the motion judder is eliminated, and compensates for the motion by inserting an interpolation frame generated according to a result of the estimation, between the previous and subsequent frames.

3. The image displaying apparatus as claimed in claim 2, wherein the interpolation frame is progressed in a middle point between the previous and subsequent frames.

4. The image displaying apparatus as claimed in claim 1, wherein the image converter converts one screen into screens having different angles.

5. The image displaying apparatus as claimed in claim 4, wherein the number (N) of the screens having the different angles is calculated as N=the number of the angles+2.

6. The image displaying apparatus as claimed in claim 1, wherein the multi-view image is a three-dimensional image according to a parallax barrier scheme.

7. The image displaying apparatus as claimed in claim 1, wherein the multi-view image is a three-dimensional image implemented in a lenticular lens scheme.

8. A method of improving picture quality by an image displaying apparatus, the method comprising:
a step of eliminating motion judder from an input image by a motion judder part;
a step of changing the frame rate of the image in which the motion judder is eliminated, by a frame rate change part;
a step of converting the image of which the frame rate is changed into a multi-view image including screens determined in proportion to the number of angles, by an image converter; and
a step of displaying the multi-view image by the display part.

9. The method as claimed in claim 8, wherein the step of changing the frame rate comprises:
estimating a motion in previous and subsequent frames of the image in which the motion judder is eliminated; and
compensating for the motion by inserting an interpolation frame generated according to a result of the estimation, between the previous and subsequent frames.

10. The method as claimed in claim 9, wherein the interpolation frame is progressed in a middle point between the previous and subsequent frames.

11. The method as claimed in claim 8, wherein the step of converting the image into the multi-view image is a step of converting one screen into screens having different angles.

12. The method as claimed in claim 11, wherein the number (N) of the screens having the different angles is calculated as N=the number of the angles+2.

13. The method as claimed in claim 8, wherein the multi-view image is a three-dimensional image according to a parallax barrier scheme.

14. The method as claimed in claim 8, wherein the multi-view image is a three-dimensional image implemented in a lenticular lens scheme.
